(19) United States
(12) Patent Application Publication
(10) Pub. No.: US 2015/0009893 A1
(43) Pub. Date: Jan. 8, 2015

(54) COMMUNICATION APPARATUS AND A METHOD OF CONTROLLING COMMUNICATION

(71) Applicant: FUJITSU COMPONENT LIMITED, Tokyo (JP)

(72) Inventors: Toshiya Koyama, Tokyo (JP); Tohru Muramatsu, Tokyo (JP); Takeshi Wakui, Tokyo (JP); Kazuyuki Ito, Tokyo (JP)

(21) Appl. No.: 14/306,339

(22) Filed: Jun. 17, 2014

(30) Foreign Application Priority Data
Jul. 5, 2013 (JP) 2013-142138

(51) Int. Cl. H04W 40/02; H04W 40/08; H04W 12/00

(52) U.S. Cl. CPC H04W 40/02; H04W 12/00; H04W 40/08
USPC 370/328

(57) ABSTRACT

A communication apparatus communicating with a wireless communication apparatus includes a control unit that controls communication; a wireless processing unit that converts a signal to be sent to a wireless signal; input and output units inputting or outputting the wireless signal between a transmission path and the corresponding input and output unit; and a first switch corresponding to input and output units and switch output destinations of the wireless signal from the wireless processing unit to any input and output unit, wherein the control unit detects the input and output unit and controls the first switch to switch over an output destination of the wireless signal to the input and output unit connected to the transmission path connected to the wireless communication apparatus, wherein the first switch switches over the output destination of the wireless signal to the input and output unit connected to the transmission path.

### CROSS-REFERENCE TO RELATED APPLICATIONS

This patent application is based upon and claims the benefit of priority of Japanese Patent Application No. 2013-142138 filed on Jul. 5, 2013, the entire contents of which are incorporated herein by reference.

### BACKGROUND OF THE INVENTION

1. Field of the Invention

The present invention relates to a communication system.

2. Description of the Related Art

In recent years, mobile devices accessible to a high speed local area network (LAN) such as IEEE (the Institute of Electrical and Electronic Engineers) 802.11 are in widespread use. Further, areas enabling connections with wireless access points are expanding. Further, in-home network apparatuses enabling connections with tablet PC through wireless interfaces (I/F) are in widespread use.

A wireless communication is always subject to the danger of being intercepted. Therefore, it is psychologically inhibited to send or receive secret information such as personal information by wireless communication. Further, in ensuring an interconnection, an access point of a public wireless LAN ordinarily employs a vulnerable encryption method such as Wired Equivalent Privacy (WEP) instead of a relatively strong standard such as a Wi-Fi Protected Access 2 (WPA 2). Therefore, there is concern relating to security.

For example, Japanese Laid-open Patent Publication No. 2013-31003 discloses a technique of transmission through a coaxial cable between a wireless unit (an RF unit) and a wireless emission unit.

For example, Japanese Laid-open Patent Publication No. 2010-45794 discloses a technique of switching by an RF switch between a route to an antenna and a route to an RF switch.

### SUMMARY OF THE INVENTION

According to an aspect of an embodiment of the present invention, there is provided a communication apparatus that communicates with a wireless communication apparatus including a control unit that controls communication with the wireless communication apparatus; a wireless processing unit that converts a signal to be sent to the wireless communication apparatus to a wireless signal; a plurality of input and output units that input or output the wireless signal between a transmission path connected to the wireless communication apparatus and the corresponding input and output unit; and first switch connected to the input and output units and switch output destination of the wireless signal from the wireless processing unit to any one of the input and output units, wherein the control unit detects the input and output unit to which the transmission path is connected, and controls the first switch to switch over an output destination of the wireless signal received from the wireless processing unit to the detected input and output unit, wherein the first switch switches over the output destination of the wireless signal received from the wireless processing unit in accordance with a control by the control unit.

### BRIEF DESCRIPTION OF THE DRAWINGS

FIG. 1 illustrates a communication system according to an embodiment;

FIG. 2 illustrates an access point of an embodiment;

FIG. 3 is a functional block diagram illustrating an access point of the embodiment;

FIG. 4 illustrates a table indicative of a correspondence between routing information and address information;

FIG. 5 illustrates a communication apparatus of the embodiment;

FIG. 6 is a functional block diagram illustrating a communication apparatus of the embodiment;

FIG. 7 is a flowchart illustrating an operation of the communication system of the embodiment;

FIG. 8 is a flowchart illustrating the operation of the communication system of the embodiment;

FIG. 9 is a flowchart illustrating the operation of the communication system of the embodiment;

FIG. 10 illustrates a modified example of an access point;

FIG. 11 illustrates an example of a connector;

FIG. 12 illustrates an example of the connector; and

FIG. 13 illustrates a modified example of the access point.

### DESCRIPTION OF EMBODIMENTS

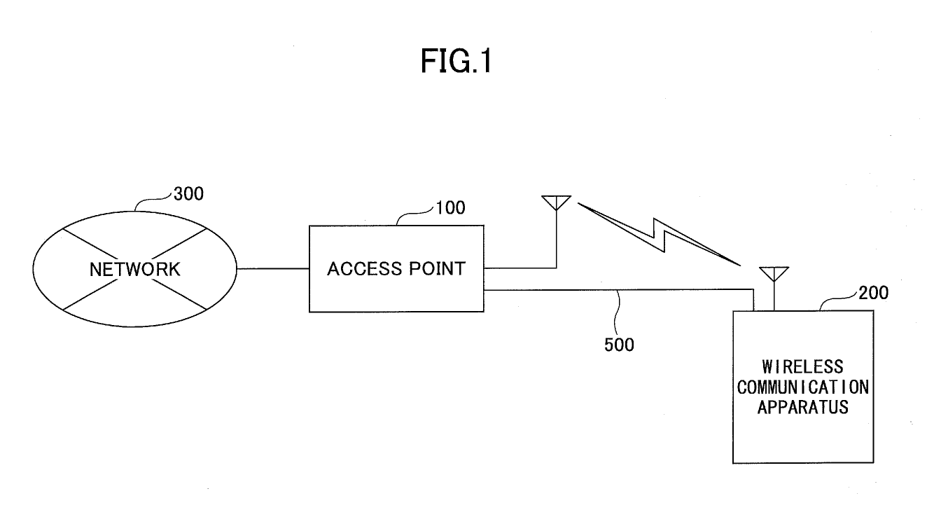

A description of embodiments of the present invention is given below, with reference to FIG. 1 through FIG. 13.

The embodiments described below are only examples and the present invention is not limited to the embodiments.

Through all figures illustrating the embodiments, the same references symbols are used for portions having the same function, and repetitive explanations of these portions are omitted.

### <Communication System>

FIG. 1 illustrates a communication system.

The communication system illustrated in FIG. 1 includes an access point 100 as a communication apparatus and a wireless communication apparatus 200. FIG. 1 illustrates only one unit of the wireless communication apparatus.

The access point 100 is a wireless apparatus for connecting the wireless communication apparatus 200 with the network 300 through wireless LAN.

The wireless communication apparatus 200 communicates with a server or a communication terminal which exists on the network 300 through the network 300.

In the communication system of the embodiment, a transmission path 500 for transmitting a signal such as a high-frequency coaxial cable (hereinafter, referred to as a “cable”) is used to connect the access point and the wireless communication apparatus 200. Specifically, a wireless unit (an RF unit) of the access point 100 is connected with a wireless unit (an RF unit) of the communication apparatus 200 by a wired connection through a cable 500. A modulated signal which is converted to a wireless signal is transmitted between the access point 100 and the wireless communication apparatus 200 through the cable 500. The wireless signal is electromagnetic waves having a wireless frequency. The modulated signal is a signal obtained by modulating data with a predetermined modulation method. By transmitting the modulated signal which is converted to the wireless signal through the cable 500, it is possible to perform an access control securely against sniffing.

### <Access Point 100>

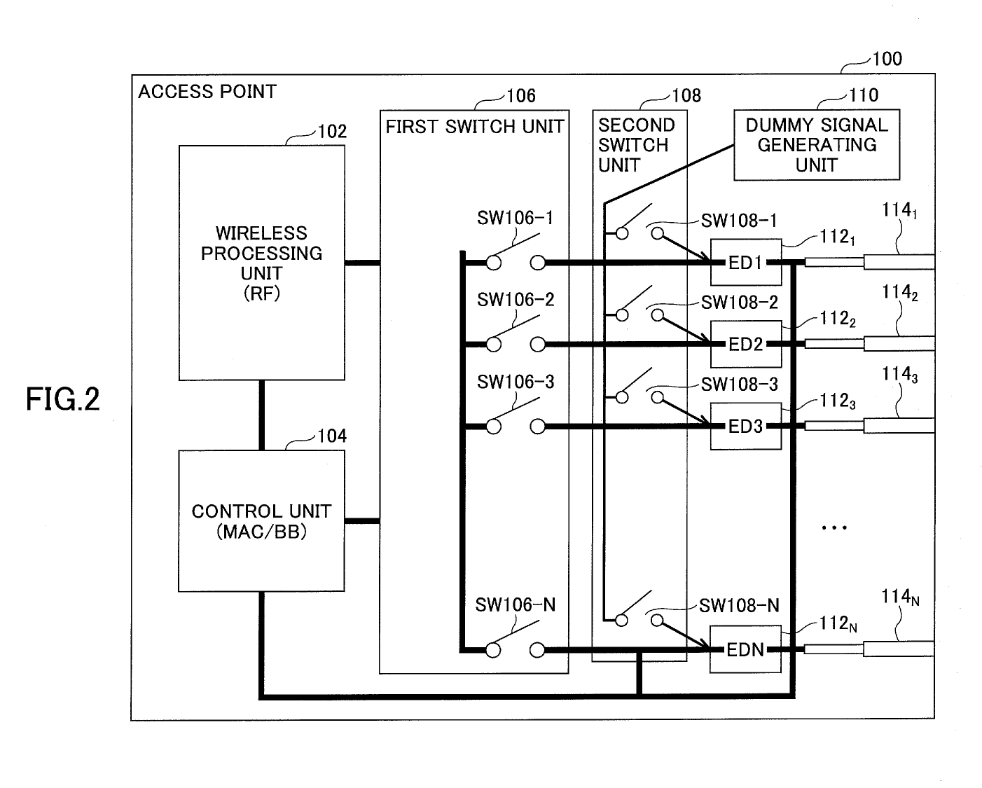

FIG. 2 illustrates an access point 100 of the embodiment. FIG. 2 mainly illustrates a portion of the access point 100 for wired connection for a high-frequency signal transmission.

The access point 100 includes a wireless processing unit 102, a control unit 104, a first switch unit 106, a second switch unit 108, a dummy signal generating unit 110, electric field intensity sensors (ED) 112₁ to 112_{N} (N is an integer, where N>1) and connectors 114₁ to 114_{N}.

The wireless processing unit 102 modulates and converts a baseband signal from the control unit 104 to the wireless signal. Further, the wireless processing unit 102 demodulates and converts the wireless signal received from the first switch unit 106 to a baseband signal, and sends the converted baseband signal to the control unit 104.

The control unit 104 is connected with the wireless processing unit 102 and detects an event that the access point 100 starts communication with the wireless communication apparatus 200.

The first switch unit 106 is connected with the wireless processing unit 102. The first switch unit 106 includes multiple switches SW106-1 to SW106-N. The first switch unit 106 turns on or off the switches SW106-1 to SW106-N by a control of the control unit 104.

The second switch unit 108 includes multiple switches SW108-1 to SW108-N. The second switch unit 108 turns on or off the switches SW108-1 to SW108-N by a control of the control unit 104.

The dummy signal generating unit 110 is connected with the second switch unit 108, and generates a dummy signal by a control of the control unit 104. A dummy signal generated by the dummy signal generating unit 110 is output from the access point to an outside through switch(es) SW108-1 to SW108-N, which is/are ON.

The electric field intensity sensors 112₁ to 112_{N} are connected with corresponding connectors 114₁ to 114_{N}, respectively. The electric field intensity sensors 112₁ to 112_{N} measure electric field intensity of the signals input from the corresponding connectors 114₁ to 114_{N}. The values of electric field intensity of the input signals measured by each of the electric field intensity sensor 112₁ to 112_{N} are input into the control unit 104.

A cable 500 connected with the wireless communication apparatus 200 is connected with any of the connectors 114₁ to 114_{N} when connecting the access point 100 and the wireless communication apparatus 200.

### <Access Point 100>

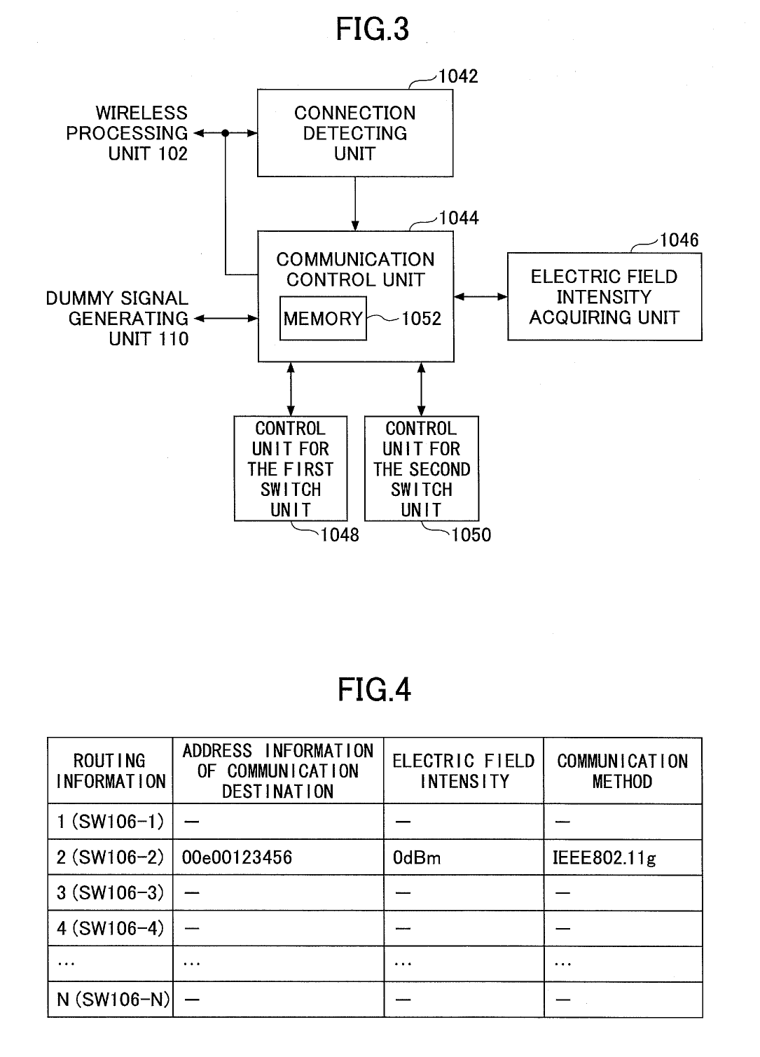

FIG. 3 is a functional block diagram illustrating access point 100 of the embodiment.

Functions of the access point 100 illustrated in the functional block diagram of FIG. 3 are mainly performed by the control unit 104. The control unit 104 is substantialized by an arithmetic processing unit such as a CPU. The control unit 104 functions as a connection detecting unit 1042, a communication control unit 1044, an electric field intensity acquiring unit 1046, a first switch unit control unit (a first control unit) 1048 and a second switch unit control unit (a second control unit) 1050.

The control unit 104 performs functions of a connection detecting unit 1042, a communication control unit 1044, an electric field intensity acquiring unit 1046, a first switch unit control unit 1048, and a second switch unit control unit 1050 by executing an application program stored in the control unit 104 or an application program (firmware) stored in a memory unit (not illustrated) which is provided outside the control unit 104.

The connection detecting unit 1042 detects whether the access point 100 is connected with the wireless communication apparatus 200 by the cable 500, or is communicating with the wireless communication apparatus 200 through the cable 500.

The connection detecting unit 1042 may determine whether the access point 100 is communicating with the wireless communication apparatus 200 by detecting a signal from the wireless communication apparatus 200 connected with the access point 100. Specifically, the connection detecting unit 1042 detects an existence of communication when a probe request or an authentication frame received from the wireless communication apparatus 200 is detected. In an active scan, the wireless communication apparatus 200 sends Extended Service Set Identifier (ESSID) as a probe request when the wireless communication apparatus 200 is connected to the access point 100.

Further, the connection detecting unit 1042 may transmit a beacon frame to an outside of the access point 100 so as to detect the existence of communication when authentication of the beacon frame is performed. In a passive scan, a beacon frame is broadcasted from the access point 100. The wireless communication apparatus 200 receives a beacon frame from the access point, checks ESSID, and performs authentication.

The connection detecting unit 1042 reports a start of the communication to the communication control unit 1044 when the wireless communication apparatus starts the communication to the access point 100.

The communication control unit 1044 is connected to the connection detecting unit 1042 and has a memory 1052. The communication control unit 1044 acquires electric field intensity measured by the electric field intensity sensors 112₁ to 112_{N} from the electric field intensity acquiring unit 1046 when the connection detecting unit 1042 reports the start of the communication to the communication control unit 1044. The communication control unit 1044 determines a connector from which a signal from the wireless communication apparatus 200 is input based on the electric field intensity measured by the electric field intensity sensors 112₁ to 112_{N} acquired from the electric field intensity acquiring unit 1046.

The communication control unit 1044 compares the acquired electric field intensities measured by the electric field intensity sensors 112₁ to 112_{N}, and determines one of the connectors from which the highest electric field intensity is detected. Such comparison is performed because signals may be input from multiple wireless communication apparatuses into multiple connectors, and may cause the communications to compete.

The communication control unit 1044 detects a transmission route of the signal by determining one of the switches SW106-1 to SW106-N connected to the connector to which the signal is determined to be input. The communication control unit 1044 stores address information of a communication destination attached to the received signal in association with the detected transmission route.

FIG. 4 illustrates a table stored in memory 1052 indicative of a correspondence between the address of the communication destination and the transmission route.

The table stores an identifier of the routing information (switch) and the address information of the communication destination communicating through the switch. The table illustrated in FIG. 4 also stores an electric field intensity of a signal input from the connector corresponding to each switch and a communication method used for a communication with the communication destination.

Each switch SW106-1 to SW106-N included in the first switch unit 106 are associated with the routing information stored in the table. The transmission route formed by turning on SW106-1 is represented by “route 1”. The transmission route formed by turning on SW106-2 is represented by “route 2”. The transmission route formed by turning on SW106-N is represented by “route N”.

A MAC address of the communication destination is stored as the address of the wireless communication apparatus in the table illustrated in FIG. 4. The information stored as the address information is not limited to the MAC address, and may be an identifier different from the MAC address such as an IP address. In the example illustrated in FIG. 4, a MAC address of “00e00123456” is stored as address information of the communication destination communicating using “route 2”.

The electric field intensity measured by the electric field intensity sensor corresponding to each switch is stored in the table. A value “OdBm” is stored in the table illustrated in FIG. 4 as the electric field intensity of the signal from the communication destination communicating using “route 2”.

Information indicative of the communication method used for the communication between the access point 100 and the wireless communication apparatus 200 is stored in table. “IEEE 802.11g” is stored in the table illustrated in FIG. 4 as a communication method of the wireless communication apparatus 200 which communicates using “route 2”.

The communication control unit 1044 commands the first control unit 1048 to turn on any of the switches SW106-1 to SW106-N corresponds to a transmission route communicating with the wireless communication apparatus 200, and turn off the other switches.

The communication control unit 1044 commands the second control unit 1050 to turn off any of the switch SW108-1 to SW108-N corresponds to the transmission route communicating with the wireless communication apparatus 200, and turn on the other switches.

The communication control unit 1044 commands the dummy signal generating unit 110 to generate a dummy signal.

The dummy signal generating unit 110 generates the dummy signal in accordance with the command from the communication control unit 1044. The dummy signal generated by the dummy signal generating unit 110 is input into a route other than the transmission route transmitting the signal from the wireless communication apparatus 200.

The communication control unit 1044 sends a signal to be sent to the wireless communication apparatus 200 to the wireless processing unit 102. The signal input into the wireless processing unit 102 is sent to the wireless communication apparatus 200 through the first switch unit 106 and the connector 114.

The communication control unit 1044 commands the dummy signal generating unit 110 to stop sending the dummy signal when the transmission of the signal to the wireless communication apparatus 200 ends. The dummy signal is therefore not sent outside the access point 100. Further, the communication control unit 1044 commands the second control unit 1050 to turn off all the switches SW108-1 to SW108-N of the second switch unit 108. Further, the communication control unit 1044 commands the first control unit 1048 to turn on all the switches SW106-1 to SW106-N of the first switch unit 106.

### <Wireless Communication Apparatus 200>

FIG. 5 illustrates an embodiment of the wireless communication apparatus 200.

The wireless communication apparatus 200 includes a wireless processing unit 202, a control unit 204, a switch 206, an antenna 208, and a connector 210.

The wireless processing unit 202 modulates and converts a baseband signal input from the control unit 204 to a wireless signal, and sends the converted wireless signal to a switch 206. Further, the wireless processing unit 202 demodulates and converts the wireless signal received from the switch 206 to a baseband signal, and sends the converted baseband signal to the control unit 204.

The control unit 204 is connected to the wireless processing unit 202 and performs a connection process for connecting the wireless communication apparatus 200 to the access point 100 for communicating with the access point 100 when the access point 100 is connected to the wireless communication apparatus 200 through the cable. For example, the control unit 204 performs a connection process between the wireless communication apparatus 200 and the access point 100 when the cable is connected to the connector 210. The control unit 204 performs a disconnection process between the wireless communication apparatus 200 and the access point 100 when the cable is disconnected from the connector 210.

The switch 206 is connected to the wireless processing unit 202, the connector 210, and an antenna 208, and switches a connection destination between the antenna 208 and the connector 210 under a control by the control unit 204.

The antenna 208 sends a wireless signal sent from the wireless processing unit 202 through the switch 206 to the outside of the wireless communication apparatus 200, and receives the wireless signal from the access point 100.

A cable connected to the access point 100 is connected to the connector 210 when wire-connecting the access point 100 with the wireless communication apparatus 200.

Further, an attenuator for attenuating the wireless signal sent from the wireless processing unit 202 through the switch 206 may be provide to the wireless communication apparatus 200. When providing the attenuator, it is preferable to provide the attenuator between the switch 206 and the connector 210. The attenuator is used when the cable is connected to the connector 210. This is because the wireless signal basically does not need to be attenuated when the wireless signal is wirelessly transmitted through the antenna 208.

### <Function of Wireless Communication Apparatus 200>

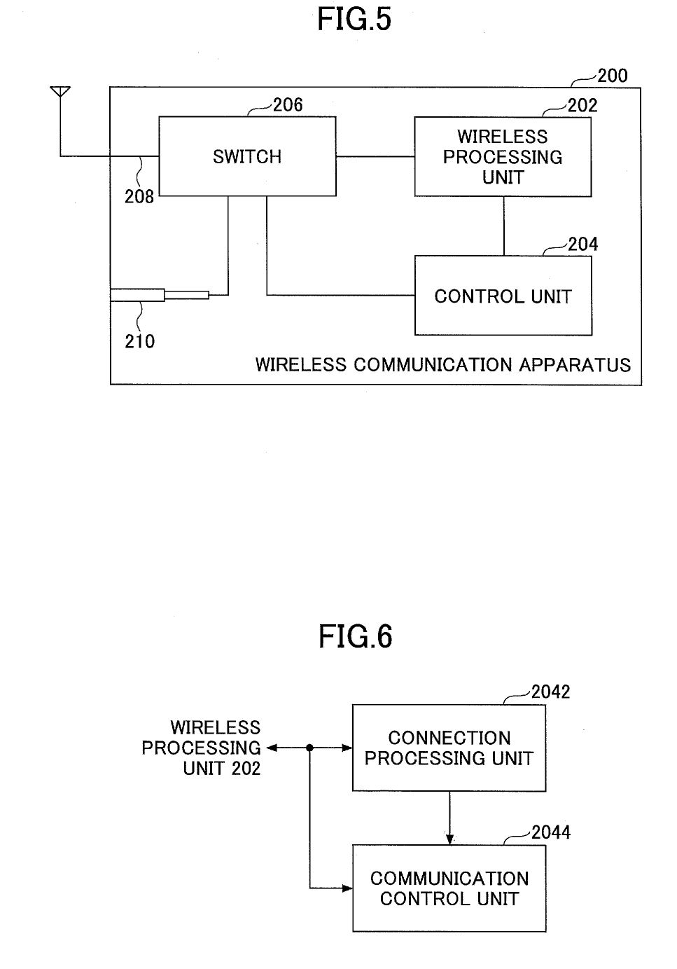

FIG. 6 is a functional block diagram of the wireless communication apparatus 600.

Functions illustrated by the functional block diagram of FIG. 6 are mainly performed by the control unit 204. The control unit 204 is substantialized by an arithmetic processing unit such as a CPU. The control unit 204 functions as a connection processing unit 2042 and a communication control unit 2044.

The control unit 204 performs functions of the connection processing unit 2042 and the communication control unit 2044 by executing an application program stored inside the control unit 204 or an application program (firmware) stored in a memory unit (not illustrated) provided outside the control unit 204.

The connection processing unit 2042 controls the switch 206 to switch over between the antenna 208 and the connector 210 so that a transmission route is formed between the connector 210 and the wireless processing unit 202 when the access point 100 and the wireless communication apparatus 200 are connected through the cable. The connection processing unit 2042 sends the probe request to the wireless processing unit 202. The probe request sent to the wireless processing unit 202 is output from the connector 210 through the switch 206. The connection processing unit 2042 reports sending of the probe request to the communication control unit 2044.

The communication control unit 2044 is connected to the connection processing unit 2042 and performs a communication control between the wireless communication apparatus 200 and the access point 100.

### <Operation of Communication System>

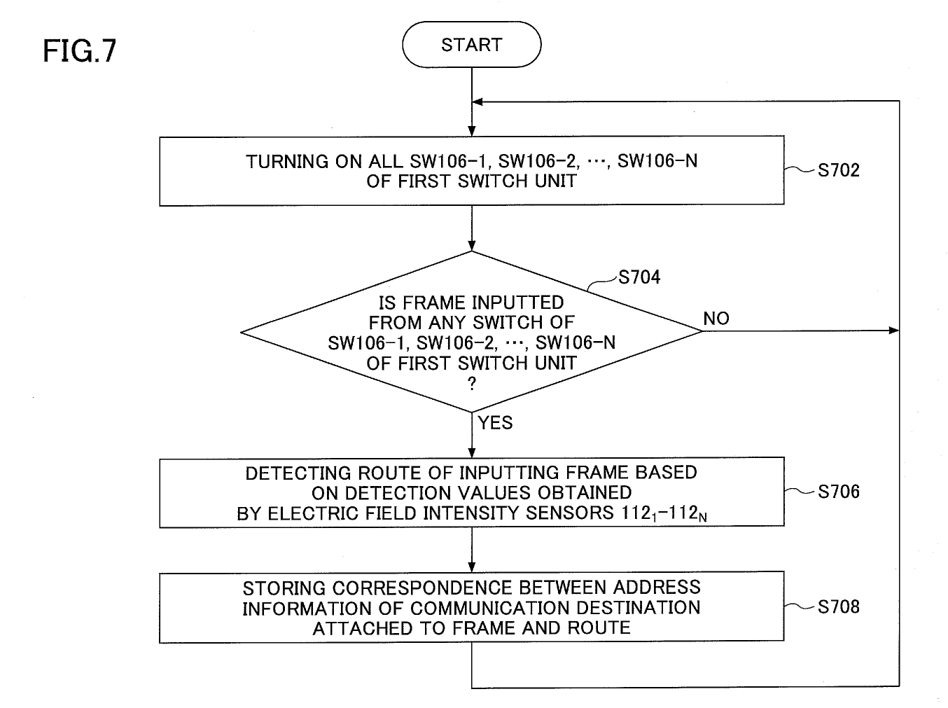

FIG. 7 is a flowchart illustrating an operation of the communication system of the embodiment. FIG. 7 mainly illustrates the operation of the access point 100.

In step S702, the access point 100 turns on all switches SW106-1 to SW106-N of the first switch unit 106.

In step S704, the access point 100 determines whether a frame is input from any of the switches SW106-1 to SW106-N of the first switch unit. When the wireless communication apparatus 200 is connected through the connector 114₂, the probe request is sent from the wireless communication apparatus 200 through the connector 114₂. The connection detecting unit 1042 determines whether the frame is input by detecting the probe request from the wireless communication apparatus 200.

In step S704, if the access point 100 determines that no frame is input from any of the switches SW106-1 to SW106-N of the first switch unit, the process goes to step S702.

In step S704, if the access point 100 determines that the frame is input from any of the switches SW106-1 to SW106-N of the first switch unit, the process goes to step S706. In step S706, the access point 100 detects the route through which the frame is input based on the electric field intensity measured by the electric field intensity sensors 112₁ to 112_{N}.

In step S708, the access point 100 obtains the address information of the communication destination from the received frame. The access point 100 stores the obtained address information of the communication destination in the table.

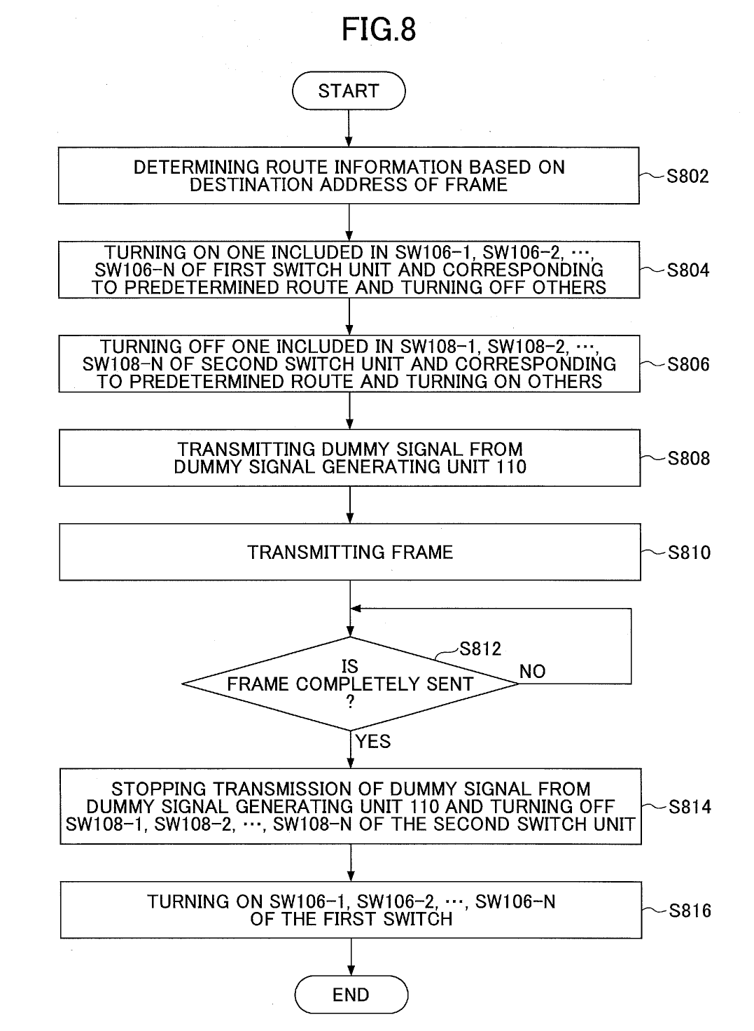

FIG. 8 is a flowchart illustrating the operation of the communication system of the embodiment. FIG. 8 mainly illustrates the operation of the access point 100.

In step S802, the access point 100 refers to the table and determines the transmission route through which the frame is received based on destination address information of the frame.

In step S804, the access point 100 turns on any of the switches SW106-1 to SW106-N of the first switch unit 106 that corresponds to the transmission route determined in step S802, and turns off the other switches.

In step S806, the access point 100 turns off any of the switches SW108-1 to SW108-N of the second switch unit 108 that corresponds to the transmission route determined in step S802, and turns on the other switches.

In step S808, the dummy signal generating unit 110 of the access point 100 generates the dummy signal. The dummy signal generated by the dummy signal generating unit 110 is sent outside the access point 100 through the switches of the second switch unit that are turned on in step S806. However, the dummy signal is not sent through the transmission routes through which the frame is received corresponding to the switch which is turned off in step S806. By sending the dummy signal through the route other than the transmission route connected to the wireless communication apparatus 200 and communicating with the access point, a Carrier Sense Multiple Access/Collision Avoidance (CSMA/CA) can be substantialized. Said differently, the wireless communication apparatus 200 communicating with the access point is set up, and even if another wireless communication apparatus tries to connect to the access point 100 while the frame is sent from the access point to a specific wireless communication apparatus, the another wireless communication apparatus detects the dummy signal sent from the access point 100 during carrier sense. Therefore, another wireless communication apparatuses cannot connect to the access point 100. In this case, another wireless communication apparatuses may perform carrier sense after a passage of a predetermined time.

In step S810, the access point 100 produces the frame and sends the frame to the wireless communication apparatus of the communication destination through the transmission route corresponding to the switch turned on in step S804.

In step S812, the access point 100 determines whether the frame had been sent to the wireless communication apparatus. In a case where it is determined that the frame had not been sent yet, the process returns to step S812.

In a case where it is determined that the frame had been sent in step S812, the access point 100 stops sending of the dummy signal in step S814 by turning off all the switches SW108-1 to SW108-N of the second switch unit 108. By stopping the sending of the dummy signal, another wireless communication apparatuses do not detect a busy state during carrier sense. Therefore, another wireless communication apparatuses may send the frame to the access point 100.

In step S816, the access point 100 turns on all switches SW106-1 to SW106-N of the first switch unit 106.

### First Modified Example

Hereinbelow, a first modified example of the communication system according to the embodiment is described. The communication system of the first modified example is based on the communication system illustrated in FIG. 1.

In the communication system of the first modified example, the access point 100 turns on any of the switches SW106-1 to SW106-N of the first switch unit 106 that corresponding to the transmission route through which the frame is determined to be input, and turns off the other switches, immediately at a timing when the transmission route through which the frame is input is detected.

Further, the access point 100 turns off any of the switches SW108-1 to SW108-N of the second switch unit 108 corresponding to the transmission route through which the frame is determined to be input, and turns on the other switches and sends the dummy signal through the switches turned-on, immediately at a timing when the route through which the frame is input is detected.

For example, the access point 100 may turn on any of the switches SW106-1 to SW106-N that corresponds to the transmission route through which the frame is determined to be input, and turn off the other switches immediately at a timing when the preamble or the header of the frame is detected. It is possible to rapidly determine the transmission route through which the frame is input by detecting the preamble or the header of the received frame. Further, the access point 100 may turn off any of the switches SW108-1 to SW108-N of the second switch unit 108 that corresponds to the transmission route through which the frame is determined to be input and turn on the other switches and sends the dummy signal at the same timing as controlling the first switch unit 106.

In the first modified example, the switches are turned on or off immediately at a timing when the preamble or the header of the frame is detected. Thus, the frame input from the wireless communication apparatus 200 is not input to the wireless processing unit 102 through the switch, while storing the correspondence between the address information of the communication destination attached to the frame and the route into the table and determining the routing information based on the stored destination address of the frame. Consequently, it is possible to keep a secret of a signal sent from the wireless communication apparatus.

### <Operation of Communication System>

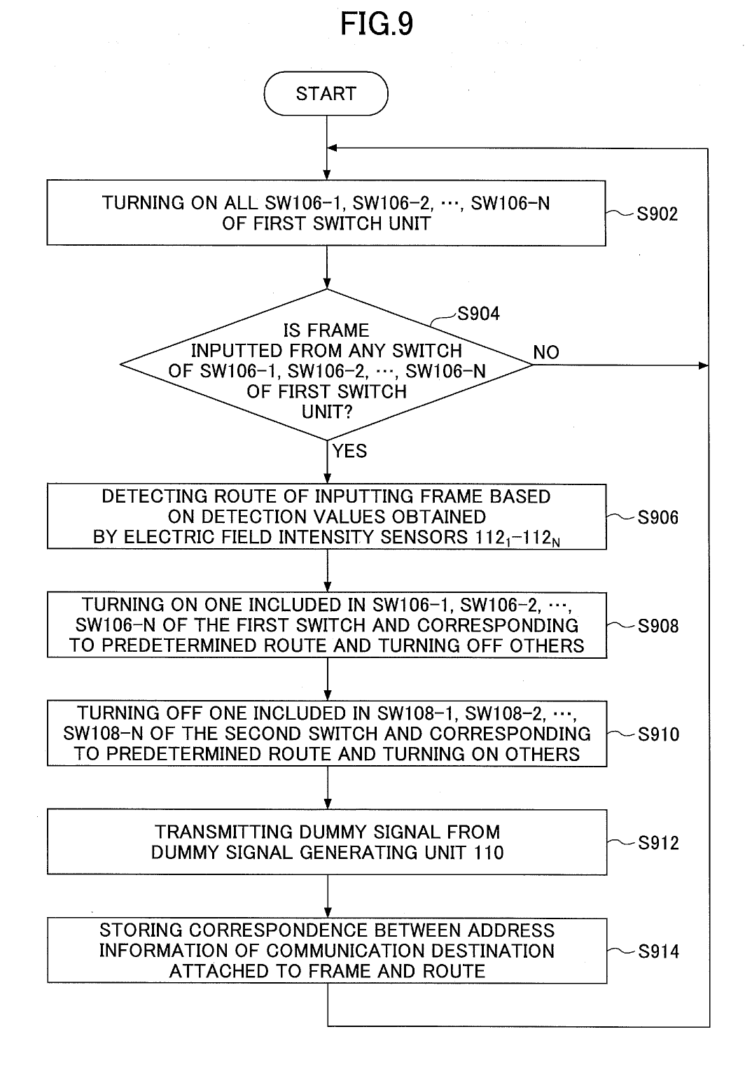

FIG. 9 is a flowchart illustrating the operation of the communication system of the first modified example. FIG. 9 mainly illustrates the operation of the access point 100.

In step S902, the access point 100 turns on all switches SW106-1 to SW106-N of the first switch unit 106.

In step S904, the access point 100 determines whether a frame is input from any of the switches SW106-1 to SW106-N of the first switch unit 106. When the wireless communication apparatus 200 is connected through the connector 114₂, the frame is sent from the wireless communication apparatus 200 through the connector 114₂. The wireless processing unit 102 determines whether the frame is input by detecting the preamble or the header of the frame from the wireless communication apparatus 200.

In step S904, if the access point 100 determines that no frame is input from any of the switches SW106-1 to SW106-N of the first switch unit, the process goes to step S902.

In step S904, if the access point 100 determines that the frame is inputted from any of the switches SW106-1 to SW106-N of the first switch unit, the process goes to step S906. In step S906, the access point 100 detects the transmission route through which the frame is input based on the electric field intensity measured by the electric field intensity sensors 112₁ to 112_{N}.

In step S908, the access point 100 turns on any of the switches SW106-1 to SW106-N of the first switch unit 106 that corresponds to the determined transmission route and turns off the other switches, immediately at a timing when the transmission route through which the frame is input is detected in step S906. For example, if the turning on the switch SW106-2 and turning off the other switches immediately at the timing when the transmission route through which the frame is input is detected, the frame input from the wireless communication apparatus 200 to the access point does not leak from the other switches which are turned off. Therefore, it is possible to keep a secret of the signal received from the wireless communication apparatus 200.

In step S910, the access point 100 turns off any of the switches SW108-1 to SW108-N of the second switch unit 108 corresponds to the determined transmission route and turns on the other switches, immediately at a timing when the route through which the frame is input is detected in step S906.

In step S912, the dummy signal generating unit 110 of the access point 100 generates a dummy signal. The dummy signal generated by the dummy signal generating unit 110 is sent outside the access point 100 through the switches of the second switch unit 108 that are turned on in step S908. However, the dummy signal is not sent through the transmission route corresponding to the switch which is turned off in step S910, through which the frame is received. By sending the dummy signal through the route other than the routes connected to the wireless communication apparatus 200 communicating with the access point, a Carrier Sense Multiple Access/Collision Avoidance (CSMA/CA) can be substantialized. Said differently, the wireless communication apparatus 200 which is communicating with the access point is set up, and even if another wireless communication apparatus tries to connect to the access point 100 while the frame is sent from the access point to a specific wireless communication apparatus, the dummy signal sent from the access point 100 is detected by the another wireless communication apparatus during carrier sense. Therefore, the other wireless communication apparatuses cannot connect to and communicate with the access point 100. In this case, the other wireless communication apparatuses may perform carrier sense after a passage of a predetermined time.

### Second Modified Example

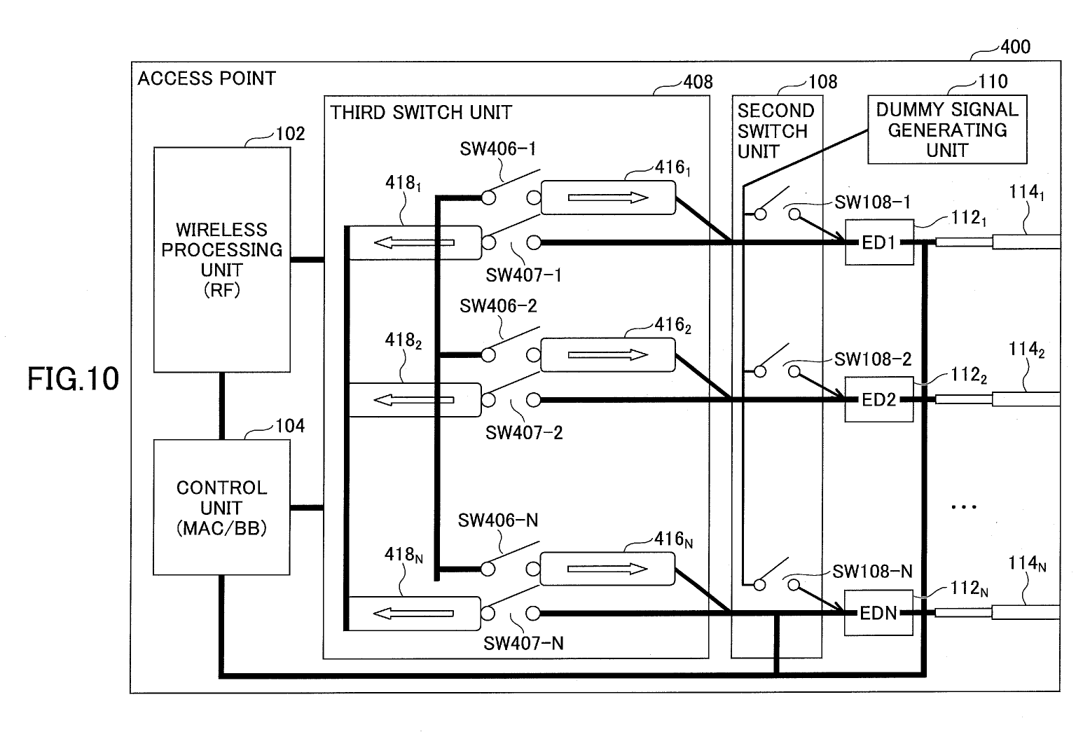

FIG. 10 illustrates the access point 100 of the second modified example.

The third switch unit 406 divides a line used for sending and receiving a signal into two systems, a sending signal line for sending information to the wireless communication apparatus 200 and a receiving signal line for receiving information from the wireless communication apparatus 200.

The third switch unit 406 includes switches SW406-1 to SW406-N and switches SW407-1 to SW407-N.

Each of the switches SW406-1 to SW406-N are provided in different sending signal line, respectively. The switches SW406-1 to SW406-N are turned off when receiving the information from the wireless communication apparatus 200. Among the switches SW406-1 to SW406-N, the switch corresponding to the transmission route through which the frame is output is turned on and the other switches are turned off when sending information to the wireless communication apparatus 200.

Each of the switches SW407-1 to SW407-N are provided in different receiving signal line, respectively. The switches SW407-1 to SW407-N are turned off when sending the information from the wireless communication apparatus 200. Among the switches SW407-1 to SW407-N, the switch corresponding to the transmission route through which the frame is input is turned on and the other switches are turned off when receiving information sent from the wireless communication apparatus 200.

Further, the third switch unit 406 includes isolators 416₁ to 416_{N} and isolators 418₁ to 418_{N}.

Each isolator 4161-416N is provided in different sending signal line, respectively. Each of the isolators 416₁-416_{N} is a one-way isolator from the wireless processing unit 102 to the second switch unit 108 and prevents a signal from leaking in a direction opposite to a sending direction.

Each of the isolators 418₁-418_{N} are provided in different receiving signal line. Each of the isolators 418₁-416_{N} is a one-way isolator from the second switch unit 108 to the wireless processing unit 102 and prevents a signal from leaking in a direction opposite to a receiving direction.

One end of each of the switches SW406-1 to SW406-N is connected to the wireless processing unit 102, and the other end of each of the switches SW406-1 to SW406-N is connected to a corresponding connector. The switches SW406-1 to SW406-N switch output destinations of the signal from the wireless processing unit 102.

Each of the isolators 416₁-416_{N} is connected to corresponding switches SW406-1 to SW406-N, respectively. Further, each of the isolators 416₁-416_{N} is connected to corresponding connectors 114₁ to 114_{N}, respectively. The isolators 416₁-416_{N} pass through the signal output from the wireless processing unit 102. However, the signals from the connectors do not pass through the isolators 416₁-416_{N}. The isolators 416₁ to 416_{N} enable the signal from the wireless processing unit 102 to pass through to the connectors 114₁ to 114_{N} only in one direction.

Each of the switches SW407-1 to SW407-N is connected to corresponding connectors 114₁ to 114_{N}. The switches SW407-1 to SW407-N are turned on or off depending on existence of inputs of the signals from the corresponding connectors 114₁ to 114_{N}. One or more switches SW407-1 to SW407-N to which the signal from the corresponding connectors 114₁ to 114_{N} are input are turned on and the other switches are turned off.

Each of the isolators 418₁ to 418_{N} is connected to corresponding switches SW407-1 to SW407-N, respectively. Further, the isolators 418₁ to 418_{N} are connected to the wireless processing unit 102. The signals input from the connectors 1141 to 114N through the corresponding switches SW407-1 to SW407-N are enabled to pass through isolators 418₁ to 418_{N}, respectively. However, the signal from the wireless processing unit 102 cannot pass through the isolators. Each of the isolators 418₁ to 418_{N} enables the signal to pass through only in one direction from the corresponding connectors 1141 to 114N to the wireless processing unit 102.

The isolator 418₁ to 418_{N} prevents the signal input from the wireless communication apparatus through the corresponding connector from leaking to the other connectors connected to the other wireless communication apparatus.

By providing the isolators 416₁ to 416_{N} to the third switch unit 406, it is possible to prevent the signal input from the corresponding connectors 114₁ to 114_{N} from leaking to the other connectors through the switches SW106-1 to SW106-N.

Further, it is possible to prevent the signal received from the wireless processing unit 102 from leaking to the switches SW407-1 to SW407-N by providing the isolators 416₁ to 416_{N} to the third switch unit 406. It is possible to prevent a signal sent from a certain wireless communication apparatus from leaking to the other wireless communication apparatuses.

### Third Modified Example

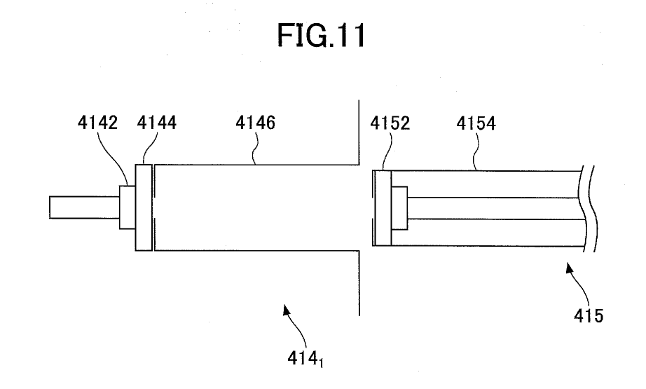

FIG. 11 illustrates a connector 414₁ of the third modified example. The connectors 414₂ to 414_{N} are the same as the connector 414₁.

Further, FIG. 11 illustrates a connector 415 connected to a cable such as a high-frequency coaxial cable for transmitting electromagnetic waves to the wireless communication apparatus 200.

Referring to FIG. 11, a reference symbol 4142 designates a conductor, a reference symbol 4144 designates an insulator, a reference symbol 4146 designates a conductor, a reference symbol 4152 designates an insulator, and a reference symbol 4154 designates a conductor.

In third modified example, the connector 414₁ is waterproof and wireless signal is transferred by AC coupling. The metallic conductor of the connector 414₁ and the metallic conductor of the connector of the connector do not directly contact.

The connector 210 of the wireless communication apparatus may have a structure similar to that in FIG. 11.

An SMA connector and a BNC connector as examples of a connector for RF are not designed to connect or disconnect many times. Depending on handling, a central conductor of such connector may be broken. By preventing the conductor of the connector 4141 from directly contacting the conductor of the connector 415, durability of the connector can be improved.

Further, it is preferable to provide waterproofing to the connectors 414₁ to 414_{N} as the SMA connector or the BNC connector has a disadvantageous waterproof property. A high frequency signal can be transmitted even if waterproofing is provided to the connectors 414₁ to 414_{N} and the connector 210, and degradation of properties such as attenuation is minimized. When the cable and the connector are connected, the signal line is preferably designed to match a specific impedance of about 50 ohm.

### Fourth Modified Example

In the communication system of a fourth modified example of the embodiment, a negotiation related to a wired connection is performed between the access point 100 and the wireless communication apparatus 200.

It is preferable to carry out negotiation for communication conditions such as signal strength between the access point 100 and the wireless communication apparatus 200.

The wireless communication apparatus may report desirable signal strength to the access point 100. For example, if the wireless communication apparatus 200 is required to receive a signal having signal strength of −50 dBm from the access point 100, the wireless communication apparatus 200 reports the desired signal strength to the access point 100. The access point 100 outputs the signal having the signal strength of −50 dBm in accordance with the signal strength reported from the wireless communication apparatus 200. The signal strength of −50 dBm is an example and can be appropriately changed.

Further, the access point may report signal strength to the wireless communication apparatus 200. For example, the access point 100 reports that a signal having signal strength of −70 dBm is sent from the access point 100 to the wireless communication apparatus 200. The wireless communication apparatus 200 is set so to receive the signal having the signal strength of −70 dBm from the access point 100 based on the signal strength reported from the access point 100. Specifically, the wireless communication apparatus 200 may change setups of an attenuator and an amplifier when necessary. Here, the signal strength of −70 dBm is an example and can be appropriately changed.

Further, the access point 100 can report that the access point 100 is ready for wired communication to the wireless communication apparatus 200. When the wireless communication apparatus 200 is reported that the access point 100 is ready for wired communication with the wireless communication apparatus 200, the wireless communication apparatus 200 can cause a user to select either of wireless communication using the antenna or wired communication using a cable. In this case, the wireless communication apparatus 200 may display a selection screen for a user for selecting wireless communication or wired communication and enables the user to select the wireless communication or the wired communication.

### Fifth Modified Example

In the communication system of the fifth modified example of the embodiment, a MIMO technique is applied to the wired communication between the access point 100 and the wireless communication apparatus 200. Because multiple inputs and outputs can be used by applying the MIMO technique, a communication performance can be improved.

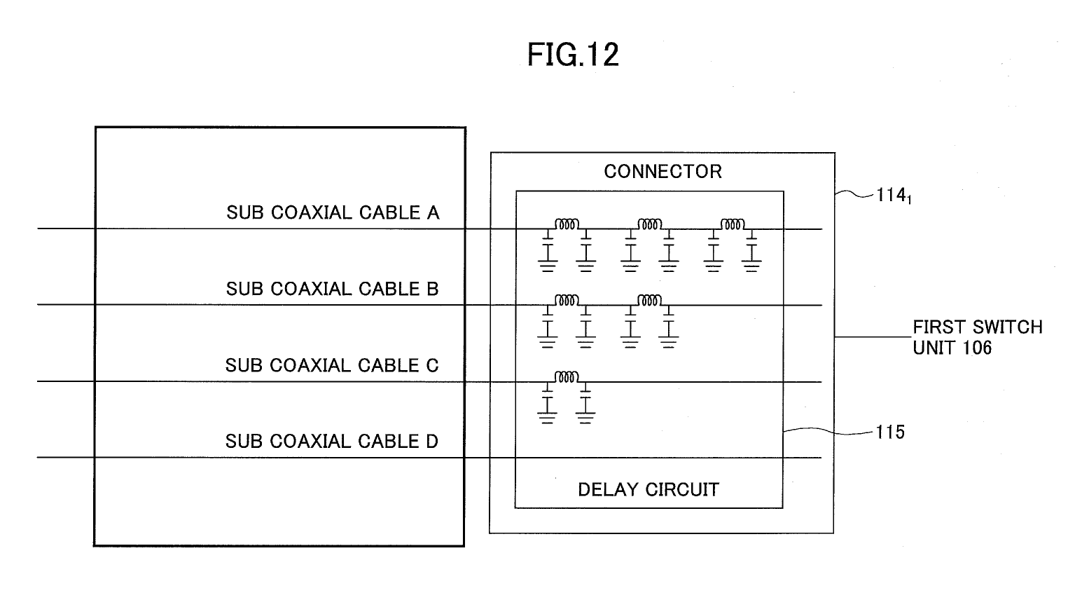

FIG. 12 illustrates an exemplary coaxial cable and a connector 114₁ used in applying the MIMO technique. The connectors 114₂ to 114_{N} are the same as the connector 114₁.

The connector 114₁ illustrated in FIG. 12 includes a delay circuit 115. For example, the delay circuit 115 is formed by a lumped parameter circuit. The lumped parameter circuit can be formed by an inductance and a capacitance. Referring to FIG. 12, 4 delay lines are formed by the inductance and the capacitance, although one of the delay lines does not contain inductance and capacitance. The impedance of each delay line of the delay circuit 115 is set to be 50 ohm.

The impedance of each delay line may be set to have a different value. The impedance of 50 ohm is an example and may be different values such as 45 ohm or 51 ohm.

In the communication system of the fifth modified example, the wireless signal from the antenna is not subjected to space division multiplexing. Therefore, it is preferable to set a delay amount of the delay circuit 115 by emulating space characteristics such as a multipath. The number of delay lines is not limited to four, but it may be 2 to 3 or 5 or more. The numbers of LC circuits formed by the inductances and the capacitances differ among the delay lines.

Four streams are input into the delay circuit 115 from the first switch unit 106. The delay circuit 115 delays the four streams by different delay amounts. The 4 streams delayed by the delay circuit 115 are sent through 4 coaxial cables, respectively. Referring to FIG. 12, 4 coaxial cables for transmitting the 4 streams delayed by the delay circuit 115 are called a sub coaxial cable A, a sub coaxial cable B, a sub coaxial cable C, and a sub coaxial cable D, respectively. The sub coaxial cable A, the sub coaxial cable B, the sub coaxial cable C, and the sub coaxial cable D are formed by a cable for transmitting electromagnetic waves such as a high-frequency coaxial cable. The sub coaxial cable A, the sub coaxial cable B, the sub coaxial cable C, and the sub coaxial cable D are preferably bundled to be one cable. The delay circuit 115 may be provided to the connector 114₁ or to the coaxial cable.

The wireless processing unit 102 divides the sending signal to 4 streams and inputs into the first switch unit 106. The first switch unit 106 inputs each of streams from the wireless processing unit 102 into the connector 114₁. Each of the 4 streams input into the connector 114₁ is input into one of the delay lines of the delay circuit 115, respectively. Each stream input into the corresponding delay line of the delay circuit 115 is transmitted by the sub coaxial cable A, the sub coaxial cable B, the sub coaxial cable C, and the sub coaxial cable D.

In the wireless communication apparatus 200, the streams transmitted by the sub coaxial cable A, the sub coaxial cable B, the sub coaxial cable C, and the sub coaxial cable D are input into the wireless processing unit 202 from the connector 210 through the switch 206. The wireless processing unit synthesizes the input streams.

Instead of delaying the streams by the lumped parameter circuit of the delay circuit 115, the delay may be provided to the streams by changing the lengths of the sub coaxial cable A, the sub coaxial cable B, the sub coaxial cable C, and the sub coaxial cable D.

In the communication system of the fifth modified example, communication quality can be improved.

### Sixth Modified Example

In a communication system of a sixth modified example of the embodiment, the access point 100 is applicable to multiple communication methods. For example, the access point 100 of the sixth modified example is applicable to IEEE 802.11b/g and IEEE 802.11a. IEEE 802.11b/g and IEEE 802.11a are examples, and the access point 100 of the sixth modified example may be applicable to other communication methods. IEEE 802.11b/g uses a frequency range of 2.4 GHz called an ISM band, and IEEE 802.11a uses a frequency range of 5 GHz. The access point 100 of the sixth modified example is provided with multiple antennas applicable to these standards of IEEE 802.11b/g and IEEE 802.11a. A dual antenna may be installed in the access point 100.

The access point 100 synthesizes the signals to generate an output signal in accordance with these standards of IEEE 802.11b/g and IEEE 802.11a, and outputs the output signal. In this case, the wireless processing unit 102 is connected to an antenna of IEEE 802.11b/g, and the output destination of the wireless signal is switched over between a port for a 2.4 GHz antenna which transmits the wireless signal in accordance with IEEE 802.11b/g, and a cable port connected to a cable. The wireless processing unit 102 is also connected to an antenna of IEEE 802.11b/g, and the output destination of the wireless signal is switched over between a port for a 5 GHz antenna which sends and receives the wireless signal in accordance with IEEE 802.11b/g, and a cable port connected to a cable.

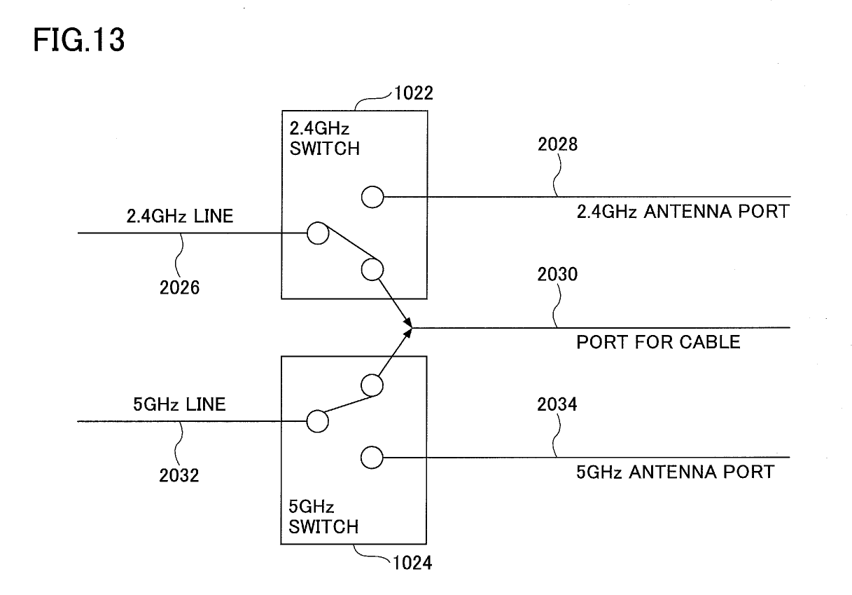

FIG. 13 illustrates a wireless processing unit 102 of the access point 100 of the sixth modified example.

The wireless processing unit 102 includes a 2.4 GHz switch 1022 and a 5 GHz switch 1024.

The 2.4 GHz switch 1022 is connected to a 2.4 GHz line 2026, a 2.4 GHz antenna port 2028, and a cable port 2030. A signal sent in accordance with IEEE 802.11b/g is transmitted through the 2.4 GHz line 2026. The 2.4 GHz switch 1022 switches over the signal sent in accordance with IEEE 802.11b/g between the 2.4 GHz antenna port and the cable port 2030.

The 5 GHz switch 1024 is connected to a 5 GHz line 2032, a 5 GHz antenna port 2034, and a cable port 2030. A signal sent in accordance with IEEE 802.11a is transmitted through the 5 GHz line 2032. The 5 GHz switch 1024 switches over the signal sent in accordance with IEEE 802.11a between the 5 GHz antenna port 2034 and the cable port 2030.

The wireless processing unit 102 switches over the 2.4 GHz switch 1022 and the 5 GHz switch 1024 to the cable port 2030 when the control unit 104 reports to the access point 100 that the wireless communication apparatus 200 is connected to the access point 100. The signal transmitted through the 2.4 GHz line 2026 in accordance with IEEE 802.11b/g and the signal transmitted through the 5 GHz line 2032 in accordance with IEEE 802.11a are output to the cable port 2030.

According to the embodiments of the communication system, wired communication can be performed using a modulation technology which is used in a wireless communication system. Further, a leak of a signal in the wired communication can be prevented. Further, an access control peculiar to the wireless communication can be performed.

According to the embodiment, communication between the wireless communication apparatus and the communication apparatus is possible while ensuring security.

All examples and conditional language recited herein are intended for pedagogical purposes to aid the reader in understanding the embodiments and the concepts contributed by the inventor to furthering the art, and are to be construed as being without limitation to such specifically recited examples and conditions, nor does the organization of such examples in the specification relate to a showing of superiority or inferiority of the embodiments. Although the communication system has been described in detail, it should be understood that various changes, substitutions, and alterations could be made hereto without departing from the spirit and scope of the invention.

What is claimed is:

1. A communication apparatus that communicates with a wireless communication apparatus, the communication apparatus comprising:
a control unit that controls communication with the wireless communication apparatus;
a wireless processing unit that converts a signal to be sent to the wireless communication apparatus to a wireless signal;
a plurality of input and output units that input or output the wireless signal between a transmission path connected to the wireless communication apparatus and the corresponding input and output unit; and
first switch connected to the input and output units and switch output destination of the wireless signal from the wireless processing unit to any one of the input and output units,
wherein the control unit detects the input and output unit to which the transmission path is connected, and controls the first switch to switch over an output destination of the wireless signal received from the wireless processing unit to the detected input and output unit,
wherein the first switch switches over the output destination of the wireless signal received from the wireless processing unit in accordance with a control by the control unit.

2. The communication apparatus according to claim 1, further comprising:
a plurality of sensors each of which corresponds to one of the input and output units and detects signal strength of the wireless signal input from the corresponding input and output unit,
wherein the control unit detects the input and output unit to which the wireless communication apparatus is connected based on the signal strength detected by the sensors.

3. The communication apparatus according to claim 1, further comprising:
a dummy signal generating unit that generates a dummy signal; and
a second switch connected to the input and output units and switches over an output destination of the dummy signal generated by the dummy signal generating unit to any of the input and output units,
wherein the control unit controls the second switch to switch over the output destination of the dummy signal to the input and output units other than the input and output signal unit which is connected to the transmission path connected to the communication apparatus,
wherein the second switch switches over the output destination of the dummy signal in accordance with a control by the control unit.

4. The communication apparatus according to claim 1,
wherein the control unit detects the input and output unit to which the transmission path is connected based on a preamble or a header contained in a frame received from the wireless communication apparatus.

5. The communication apparatus according to claim 1,
wherein the control unit acquires address information of the wireless communication apparatus when the transmission path is connected to the input and output unit, and stores the acquired address information in correspondence with the input and output unit to which the transmission path is connected.

6. The communication apparatus according to claim 1, further comprising:
first isolators each of which is provided between the wireless processing unit and one of the input and output units, enables the signal from the wireless processing unit to pass through to the corresponding input and output unit, and cut off the signal from the corresponding input and output unit to the wireless processing unit; and
second isolators each of which is provided between the wireless processing unit and one of the input and output units, enables the signal from the corresponding input and output unit to pass through to the wireless processing unit, and cut off the signal from the wireless processing unit to the corresponding input and output unit.

7. A method of controlling communication using a communication apparatus that communicates with a wireless communication apparatus, the method comprising:
detecting an input and output unit, to which a transmission path connected to a wireless communication apparatus is connected, out of a plurality of input and output units that input or output a wireless signal between the communication apparatus and the transmission path connected to the wireless communication apparatus;
controlling a plurality of first switches that correspond to the plurality of input and output units and switch output destinations of the wireless signal to any one of the plurality of input and output units to switch over an output destination of the wireless signal received from a wireless processing unit that is included in the communication apparatus to the input and output unit, which is connected to the transmission path connected to the wireless communication apparatus; and
switching over the output destination of the wireless signal received from the wireless processing unit to the input and output unit, which is connected to the transmission path connected to the wireless communication apparatus.

8. A communication apparatus that is connectable with the other communication apparatuses through a physical cable, respectively, the communication apparatus comprising:
a controller for controlling communication with the other communication apparatuses;
input and output units, each of which is connectable to the cable, for input and output transmission signal to be transmitted between the other communication apparatus through the connected cable;
a dummy signal generator for generating a dummy signal; and
a switch provided between the input and output units and the dummy signal generator, for switching output destination of the dummy signal,
wherein the controller determines any of input and output units that is connected with the other communication unit, and controls the switch to select the output destination, and
the switch connects the dummy signal generator to any of the input and output units other than the input and output unit that the controller has determined.

9. The communication apparatus according to claim 8, further comprising:
an another switch provided between the controller and the input and output units, for switching any of the input and output units to be connected to the controller;
wherein the controller controls the another switch to select any of the input and output units, and
the another switch connects the controller to the input and output units that the controller has determined.

10. The communication apparatus according to claim 8, wherein the controller determines whether the input and output unit is connected with the other communication apparatus, by determining whether the input and output unit is connected to the cable, or whether any signal is input through the input and output unit.
